(19) United States
(12) Patent Application Publication
(10) Pub. No.: US 2006/0099561 A1
(43) Pub. Date: May 11, 2006

(54) Automated assessment development and associated methods

(76) Inventor: Gerald W. Griph, San Antonio, TX (US)

Correspondence Address: JACQUELINE E. HARTT, PH.D;ALLEN, DYER, DOPPELT, MILBRATH & GILCHRIST, P.A., P.O. BOX 3791, ORLANDO, FL, 32802-3791, US

(21) Appl. No.: 11/269,120

(22) Filed: Nov. 8, 2005

Related U.S. Application Data
(60) Provisional application No. 60/626,066, filed on Nov. 8, 2004.

(51) Int. Cl. G09B 3/00

(52) U.S. Cl. 434/322

(57) ABSTRACT

An automated system and method for creating a test form that conforms to predetermined content specifications (the blueprint) and has a desired statistical profile (target statistics). The algorithm divides the test-construction problem into two phases: a content-matching phase that is followed by a statistical-matching phase. In these phases, (1) a structural skeleton is sought that fits the blueprint; and (2) a search is made among the set of all possible tests that could be created from a pool of items for at least one test that matches the desired target statistics. The algorithm performs the statistical matching in the second phase without upsetting the content match that was attained in the first phase. This is possible because the content matching takes place using content specifications that match a number of different items or sets of items rather than specific items or sets of items.

### CROSS-REFERENCE TO RELATED APPLICATION

This application claims priority to provisional application Ser. No. 60/626,066, filed on Nov. 8, 2004, entitled “Automated Assessment Development and Associated Methods.”

### BACKGROUND OF THE INVENTION

1. Field of the Invention

The present invention relates to systems and methods for creating assessments, and, more particularly, to such systems and methods that are automated.

2. Description of Related Art

Instruments created to examine a student's knowledge of a particular discipline typically include a series of questions to be answered or problems to be solved. Tests have evolved from individually authored, unitarily presented documents into standardized, multiauthor documents delivered over wide geographic ranges and on which multivariate statistics can be amassed. As the importance of test results has increased, for myriad educational and political reasons, so has the field of test creation experienced a concomitant drive towards more sophisticated scientific platforms, necessitating increased levels of automation in every element of the process.

Current practice in building a test form involves a content expert who selects the items for a new form of an existing test according to content specifications (the “blueprint”) and statistical specifications (item difficulty and item-test correlations). An objective is to build a new test form that follows the blueprint and matches the statistical properties of the pre-existing test as closely as possible. This approach has several problems. First, producing the initial iteration of a new form is very time-consuming, and can take anywhere from several days to a week or more, because of the balancing required to arrive at both a content and statistical match. For more complex test designs it may be impossible for the expert to obtain an exact match.

It is common to use item response theory to assist in test construction, wherein each item is tested in a large, diverse population, to gather statistics on each individual item. Then each item will have associated therewith an item characteristic curve, which explicates the relationship between the probability of a correct answer and the examinee ability level. Typically, when using three-parameter logistic item response theory for dichotomously scored items, such a curve will have a monotonically increasing S-shape, will range between 0.0 and 1.0, and will have its specific shape determined by the difficulty, discrimination, and pseudo-guessing parameters for the item with which it is associated. Each item will also have an associated item information curve, which typically is “bell-shaped,” with the height of the bell and its position along the x-axis determined by the item's associated difficulty, discrimination, and pseudo-guessing parameters. The item information curve depicts the amount of information that the item provides about an examinee in relationship to the examinee's level of ability. For any particular set of items that make up a particular test form, the individual item characteristic and information curves can be aggregated to produce the test characteristic and information curves, which explicate the relationship between the examinee ability level and the expected raw score of the examinee (characteristic curve). Information is better understood as the inverse of the amount of measurement error (for, if there is more information available about the examinee, a measure of their ability is more precise, with less error). Therefore, the information curve is often tailored through the judicious choice of items with high levels of information near the cutpoint of a particular assessment, for example.

Item response theory (IRT) differs from classical test theory (CTT) in that the item statistics derived through the use of IRT are not dependent on the overall level of ability of the underlying sample of examinees upon which they are based. If the statistical match were based upon CTT item statistics, which are dependent in part upon the overall ability level of the sample who responded to the item, if two different sets of students who differed in ability were to respond to the same set of items, it would be expected that the item statistics would differ between the two groups, because of the difference in the group abilities. This is problematic, since the group upon whom the target form item statistics are based is typically not the group upon whom the new form item statistics are based. To the extent that the two groups differ in their mean ability, the perceived statistical match will be inaccurate.

Therefore, it would be desirable to provide an automated system that can construct a test having a substantially exact match to the blueprint, and also through the use of IRT to construct a test whose statistical match to a pre-existing form is not confounded by differences in the overall ability distributions of their underlying samples. Because IRT-based item and test statistics are substantially more complicated to use for test construction, primarily because they vary across the continuum of examinee ability, as opposed to CTT-based item and test statistics, which are point estimates with the same values irrespective of examinee ability, they are impractical to use without computerized assistance. Therefore, automation significantly reduces the burden on the person responsible for test form construction.

Within the field of psychometrics, algorithms and heuristics for automated test construction have received a great deal of attention. One of the leading researchers in the field, Wim J. van der Linden, has worked on approaches using linear programming (a field of study concerned with optimal solutions to algebraic functions). Another prominent researcher is Richard Luecht, who favors heuristic-based approaches. Both sets of approaches attempt to solve the same problem: out of the family of possible solutions, they attempt to search for the “best” solution, which is to identify the set of items that (1) conforms to the desired blueprint, and (2) most closely matches the desired statistical characteristics. However, identification of this best form is not a trivial task: There are 9.32×1028 possible unique 48-item forms that can be constructed from a 100-item set. Clearly, an exhaustive search would be infeasible (at a rate of 1 billion forms per second, it would take 1.77×10¹⁴ years to evaluate all possible forms). The solution is to implement an efficient search that is able to quickly arrive at an acceptable solution.

All known current approaches, including those by van der Linden and by Luecht, share a common attribute: They attempt to address all constraints, both content-based and statistically-based, simultaneously. Because of this, they often are unable to arrive at a solution that is able to adequately address all constraints for a particular test-construction problem.

Therefore, it would also be desirable to provide a method that addresses these constraints.

### SUMMARY OF THE INVENTION

The present invention is directed to an automated system and method for creating a test form that conforms to predetermined content specifications (the blueprint) and has a desired statistical profile (target statistics). The system, method, and algorithm detailed herein differ from current known approaches in that the test-construction problem is divided into two phases: a content-matching phase followed by a statistical-matching phase. Specifically, in the two phases: (1) a structural skeleton is sought that fits the blueprint; and (2) a search is made among the set of all possible tests that could be created from the universe of test forms that share the structure identified in the previous step for the test that best matches the statistical targets.

The current invention is able to perform the statistical matching in the second phase without upsetting the content match that was attained in the first phase. This is possible because the content matching phase results in a structure for a test rather than an actual test comprising specific items. The structure has “slots” where items or testlets (sets of items that are dependent upon a common stimulus) can be inserted. Single items and testlets are handled in the same way by the algorithm (single items are handled as testlets comprising exactly one item) and are referred to herein as “passages.” Each slot in the structure is associated with a specific content target that matches at least one available passage present in the pool of passages available for inclusion in the test.

In essence, the first phase builds a test form skeleton, and the second phase attaches specific passages to that skeleton. This means that when the search for a statistical match takes place, that search is restricted to a subset of test forms that already match the desired content structure, resulting in a much more efficient search than would otherwise be possible. Likewise, the first phase (the search for a content match) is more efficient because, in completely disregarding statistical considerations, the system is not deterred from choosing a particular content structure because one particular implementation of that structure (which is what might be considered if simultaneously focusing on statistical and content considerations) has a poor statistical match. The current invention therefore efficiently searches the solution space for an acceptable solution, and does so using strategies different from all other current approaches to automated test form construction.

Since it is possible that many parallel forms can be constructed, the method and algorithm in an exemplary embodiment select the form that is the closest match to the test information curve and the test characteristic curve.

A method of the present invention that is directed to assembling an assessment having a predetermined target content structure and target statistics from a pool of passages. Each passage has associated therewith a content profile and passage statistics. The method comprises the steps of:

a. selecting from the passage pool a predetermined number of content profiles to create a candidate form, the candidate form having a content structure based upon a sum of the content profiles;

b. comparing the candidate form content structure with the target content structure;

c. if a difference between the candidate form content structure and the target content structure is a currently lowest value, retaining the candidate form as a closest match;

d. repeating steps (a)-(c) until the retained closest match candidate matches the target content structure;

e. populating the retained closest match candidate form with a plurality of passages meeting the form content structure to create a potential assessment;

f. calculating test statistics for the potential assessment;

g. if a difference between the calculated test statistics and the target statistics is a currently lowest value, retaining the potential assessment as a candidate assessment; and

h. repeating steps (e)-(g) until all possible potential assessments have been created.

In another aspect of the invention, a method comprises the steps (a)-(d) as above, and also comprises the steps of:

e. randomly populating the retained closest match candidate form with a plurality of passages meeting the form content structure to create a potential assessment;

f. calculating test statistics for the potential assessment;

g. repeating steps (e) and (f) a plurality of times;

h. sorting the created potential assessments according to a distance between the respective calculated test statistics and the target statistics;

i. selecting a closest potential assessment from the sorting step;

j. searching among the potential assessments for a form complementary to the closest potential assessment;

k. forming a progeny assessment by randomly selecting a sequence of alternative passages from each of the closest potential assessment and the complementary assessment;

l. calculating test statistics for the progeny assessment;

m. repeating steps (k) and (l) a plurality of times; and

n. identifying a progeny assessment having a closest match to the target test statistics.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWINGS

FIG. 1 is an exemplary passage structure.

FIGS. 2A-2F is a flowchart of an embodiment of the assessment creation method.

FIG. 3 is a graph of new and base form test information, wherein theta represents an ability scale.

FIG. 4 is a graph of new and base form test characteristic curves.

### DETAILED DESCRIPTION OF THE PREFERRED EMBODIMENTS

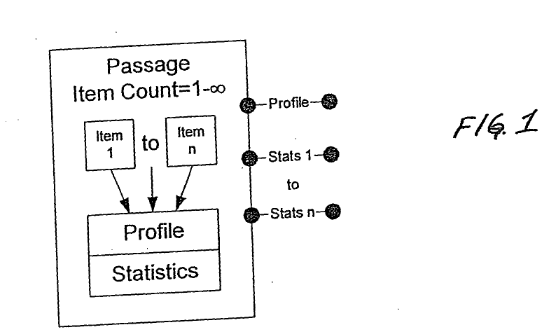

A description of the preferred embodiments of the present invention will now be presented with reference to FIGS. 1-4.

The system and method of the present invention comprise a software program that includes an algorithm that operates on sets of items which are termed “passages.” A passage is a set of one or more items that are related in some way. If a passage is selected for inclusion in a test form, this implies that all items within the passage are selected for inclusion on the test form.

The structure of a passage is shown in FIG. 1. The passage contains one or more items that contribute to the passage's profile, which is used in matching content targets, and the passage's statistics (arbitrary aggregable item-level statistics aggregated across the items that make up the passage), which are used in matching statistical targets.

Within the system, passages are implemented as objects. After the passage has been loaded with its member items, the passage profile and statistics are accessible to the system as object properties.

An exemplary structure of a passage profile is:

| | | |
|---|---|---|
| Objective 1 | . . . | Objective n |
| Count 1 | . . . | Count n |

This structure includes objective identifiers and their associated target item counts, at the finest level of content specification. The items, passages, and target test content structures can all be completely represented by this structure, and additive and subtractive functions can be implemented for this structure; such functions are useful in assessing how close the content structure of a set of passages is to a target content structure.

While the structure used to represent content and the methods used to assess the match of a set of items to the content targets are well-defined, the structure used to represent the statistical makeup of the exam and the methods used to assess the statistical match of the exam to the target are less so. Within the algorithm, the statistical portions are defined generically because there are multiple statistical models used to represent items and tests; the exact structures and methods used depend on the measurement model chosen for a specific application. IRT-based statistics are typically used, but the algorithm of the present invention also supports the use of CTT-based statistics.

An exemplary implementation of the algorithm is in Visual Basic.NET, which is an object-oriented programming language. In this embodiment, passages are implemented as objects with the passage profile and statistics represented as object properties. Passages and profiles as represented above are those data structures that are central to the algorithm. Anything beyond these structures are implementation-specific.

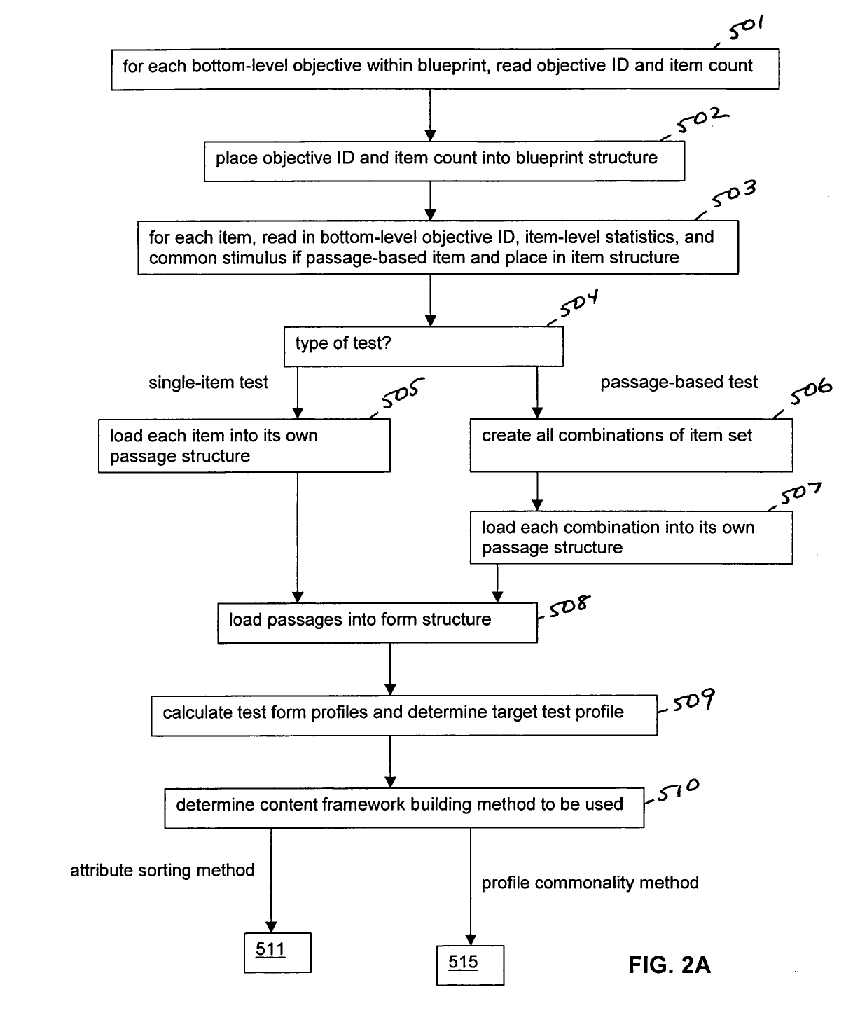

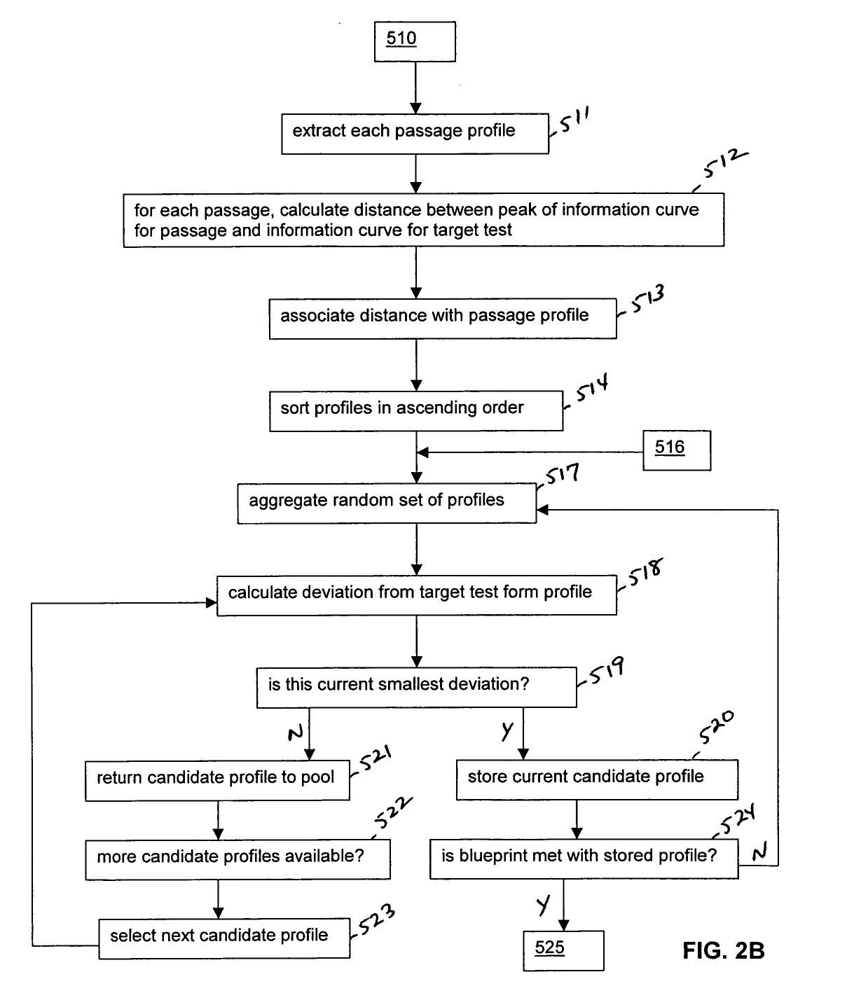

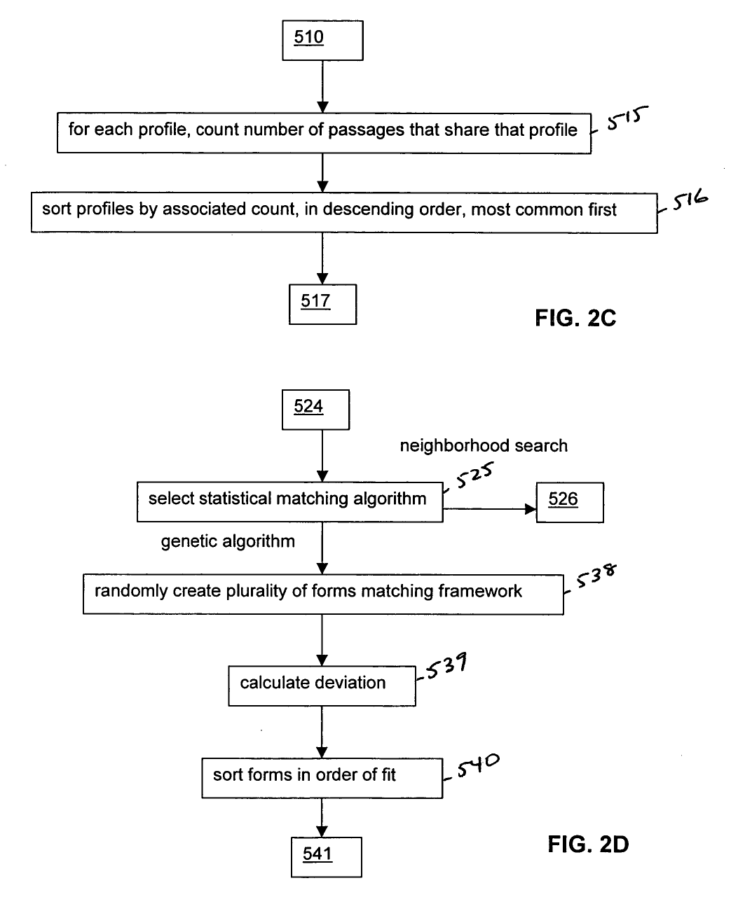

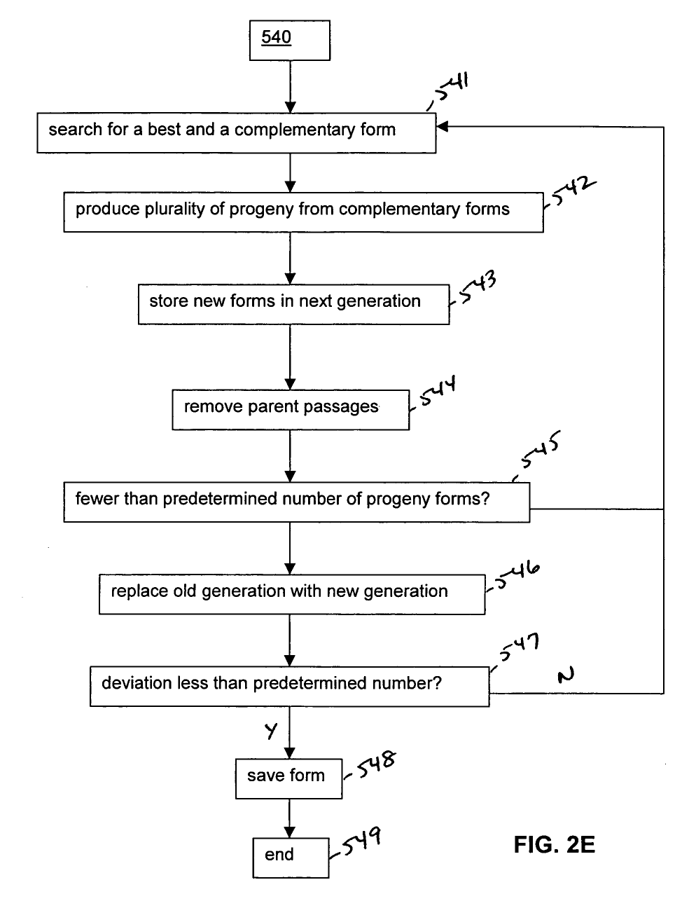

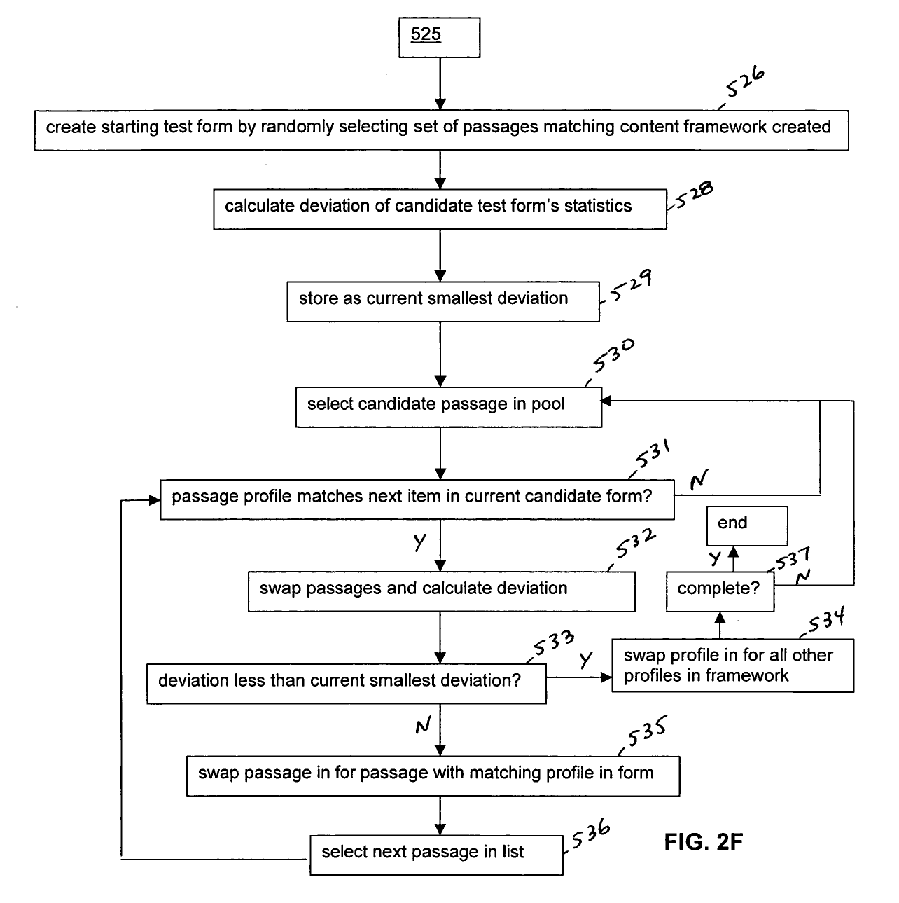

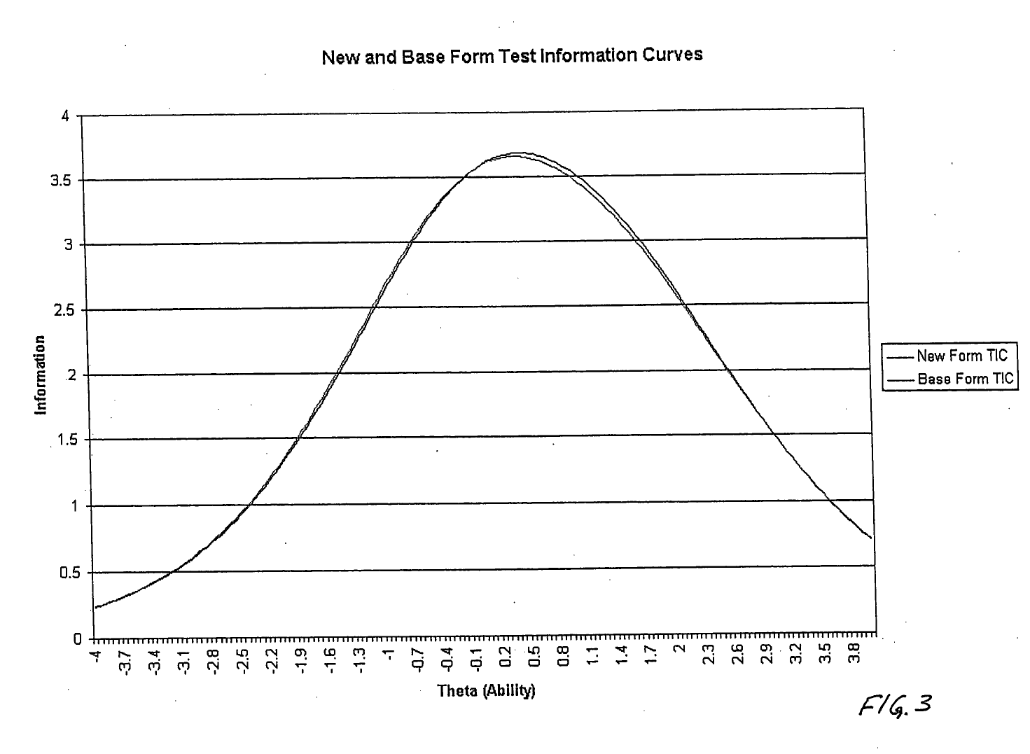

The system can operate as follows (FIGS. 2A-2F): The data are read into internal data structures. For each bottom-level objective within the blueprint, the objective ID and item count are read (block 501) and placed into the blueprint structure (block 502). For each item, both those that comprise the target form and those that comprise the pool from which the new form(s) will be built, the ID of the bottom-level objective(s) addressed by the item, the item-level statistics for the item, and the ID of the common stimulus for the item (if the item is a passage-based item) are read in and placed in a unique instance of the item structure (block 503).

After all items have been loaded into their individual item structures, passages are constructed. Depending upon the type of test (block 504), different steps are taken. For “single-item based tests” (tests with items that do not share common stimuli), each item is loaded into its own unique instance of the passage structure (block 505). The test is composed of a set of passages equal to the number of items on the exam, each of which contains exactly one item.

For “passage-based tests” (tests composed of sets of items, with the items within each set referencing a common stimulus such as a reading passage), each stimulus is generally associated with a greater number of items during the field test than will be used on the final form. For example, a certain reading test may have twelve items that reference a certain reading passage, but the final test will only have six items associated with the passage. This provides for the attrition of items. The system creates every possible combination of six items from the set of twelve items associated with the common stimulus (block 506) and loads each into its own unique instance of the passage structure (block 507). In the forgoing example (six out of twelve items), 924 unique passages (each comprising six items) are loaded into the “pool” of passages eligible for inclusion on the new exam.

The passages that comprise the target form are loaded into a unique instance of the form structure (block 508). This is the source of the test-level target statistics that the system uses. The test form profiles and calculated, and the target test profile is determined (block 509).

Once all the necessary data structures are filled, the system builds the content framework for the new exam in the first phase of operation. Each passage (i.e., a set of 1-∞ items) has associated with it a “profile,” which is a succinct description of the specific content objectives that the passage addresses. These profiles are amenable to addition and subtraction, and so the profile for a passage is simply the sum of the profiles for the items contained within that passage. Similarly, each test form has a profile, which is the sum of the profiles of the passages that comprise that form. A profile for a test form can also be constructed in the absence of a tangible form from a blueprint. The target profile constructed from the blueprints can be compared with the current candidate form to determine the deviation from the blueprint. The target profile for the test is constructed from the blueprint and stored. For each candidate passage within the pool of passages eligible for inclusion in the new form, the system extracts the profile and stores it with the profiles for all other passages within the pool.

The following two tables represent a simple example of the creation of a test profile and the construction of test. The format x|y means that passage x addresses objective y. For a test comprising two passages, the profile is created as follows:

| | 1\|1 | 2\|1 | 3\|1 |
|---|---|---|---|
| plus | 1\|0 | 2\|2 | 3\|1 |
| equals | 1\|1 | 2\|3 | 3\|2 |

Now two different attempts to match this profile are shown in the following table:

| | 1\|1 | 2\|3 | 3\|2 | target profile |
|---|---|---|---|---|
| minus | 1\|0 | 2\|0 | 3\|3 | candidate passage #1 |
| minus | 1\|2 | 2\|1 | 3\|0 | candidate passage #2 |
| equals | 1\|−1 | 2\|2 | 3\|−1 | result - not a match |
| minus | 1\|1 | 2\|1 | 3\|1 | candidate passage #3 |
| minus | 1\|0 | 2\|2 | 3\|1 | candidate passage #4 |
| equals | 1\|0 | 2\|0 | 3\|0 | result - matches target |

Two exemplary methods for building the content framework will be described, although they are not intended to be limiting (block 510). Each content framework by its very nature only draws upon a certain subset of all available passages to construct the new form. Some subsets will, by virtue of the statistical properties of their constituent passages, be more facilitative of the construction of test forms that tightly mirror the statistics of the target forms than others. It is preferable to construct content frameworks in the first phase so that the likelihood that the second phase of the system can to achieve a tight match to the target test form's statistics is maximized. The methods to be described to achieve this differ in the way that the profiles for the candidate passages extracted above are sorted.

A first sorting method sorts on attributes of passages that are commonly found in new test forms that have a tight match to the target statistics. It has been found that if the information curve for the passage peaks near the point where the information curve for the target test peaks, a new test form made up of such passages tends to have a closer match to the statistical targets than will a test form made up of passages whose information curves peak far from the peak of the target test information curve. Thus, as each passage has its profile extracted (block 511), the distance between the peak of the information curve for the passage and the information curve for the target test is calculated (block 512) and associated with the passage profile (block 513). Profiles are sorted in ascending order (block 514), so that as the system steps sequentially through the profiles, those with less distance between the peak of the passage's information curve and the target test information curve peak are considered first and thus have a higher probability of being included in the final framework.

The second sorting method is based on the supposition that a large number of alternative test forms gives one a higher probability of meeting statistical targets than a smaller number of alternatives. The profile for a particular candidate passage will most likely not be unique to that passage. Most probably, there will be other passages within the pool of passages available for inclusion in the new test that share that profile. There will be, however, profiles that are shared by only two or three passages, while for large pools, there will be other profiles shared by seventy or eighty passages. For each unique profile, the system simply counts the number of passages that share that profile (block 515). Profiles are sorted by their associated count, with the most common profiles sorted first (block 516). Thus, as the system proceeds sequentially through the profiles, the most common profiles are considered first and thus have a higher probability of being included in the final framework than do the less common profiles.

After the profiles are extracted, the first phase of the system operates solely on profiles, ignoring the underlying items and their statistics.

A random set of profiles corresponding to sufficient passages to completely populate the new form is drawn from the top part of the list of profiles and these are aggregated to form the profile for the current candidate framework (block 517). The deviation of the candidate test framework profile from the target test form profile previously created and stored is calculated (block 518). This deviation is stored as the current smallest deviation. The first profile in the list of profiles of candidate passages is selected. This profile is swapped with the first profile in the current candidate framework, and the deviation of the profile for this modified framework from the target profile is calculated. If the deviation is less than the current smallest deviation (block 519), then the modified framework becomes the current framework and is stored (block 520), and the deviation becomes the current smallest deviation. The profile that was replaced is returned to the pool.

If the deviation is not less than the current smallest deviation (block 519), then the profile is swapped in for all other profiles currently in the framework (block 521), until the last profile in the current candidate framework has been swapped and tested (block 522). The next profile in the list is selected (block 523), and the system proceeds to block 518.

Each time a successful swap is made, the system tests to see if the blueprint has been met (block 524). If the deviation is zero, the system proceeds to the second phase (block 525). If the system reaches a point where the deviation is greater than zero but no more improvement can be made, the “dead end” is discarded and the system resumes from block 517.

The system enters the second phase, that of matching of the statistical targets, with a set of profiles (the framework) that match the blueprint. At this point, any set of passages that have profiles that match this framework could be randomly selected to yield a test form that meets the blueprint. Two exemplary methods will be described for performing the statistical matching (block 525), although these are not intended as limitations.

A first example comprises a simple neighborhood search. A starting test form is created by randomly selecting a set of passages that match the content framework created in phase 1 (block 526). The deviation of the candidate test form's statistics from the target test form's statistics is calculated (block 528). This deviation is stored as the current smallest deviation (block 529). The first of the candidate passages in the pool is selected (block 530). If the profile of the passage matches the profile of the first item in the current candidate form (block 531), then the passages are swapped and the deviation of the modified test form's statistics from the target test form's statistics is calculated (block 532). If the deviation is less than the current smallest deviation (block 533), then the modified test form becomes the current candidate test form (block 534), and the deviation becomes the current smallest deviation. The passage that was replaced is returned to the pool.

If the deviation is not less than the current smallest deviation (block 533), then the passage is swapped in for any other passages with a matching profile currently in the form (block 535), until the last passage in the current candidate form has been swapped and tested (block 536). The next passage in the list is selected (block 537), and the system proceeds with block 531. The system continues until no further improvement is possible (block 536), at which point it saves the final form and terminates (block 537).

A second statistical matching method includes a genetic algorithm (block 525). In this method, the system randomly creates a large number, for example, 2000, forms that match the framework from Phase 1 (block 538). The deviation from the target test form's statistics is calculated for each (block 539), and they are sorted with the best fitting forms first (block 540).

Next the system selects the best fitting form from the set. The system searches the remaining forms for the one that best complements the currently selected form (block 541). The best complement is defined as the form with the deviations from the target statistics that best compensate for the deviations of the currently selected form. For example, if the currently selected form was 0.05 greater than the target form at all points along the test information and characteristic curves, the best complementing form would be one that was 0.05 less than the target form at all points along the curves. Essentially, the system is attempting to find the form that, when averaged with the best fitting form selected at block 541 gives the minimum deviation from the target form.

After the best complementing form has been identified, there are two test forms, each of which is based on the same framework. That means that each profile within the framework will have two passages corresponding to it, one from each of the two forms. The system produces a plurality, for example, 50, “offspring” from the two “parent” forms by randomly selecting one of the two alternative passages from each pair of passages for inclusion in the offspring form (block 542). The new forms are stored along with their parents in the next generation of test forms (block 543). The parent passages are removed from the current generation of forms (block 544), and the system resumes with block 541 if fewer than a predetermined number, for example, 50, pairs of test forms have been bred (block 545). If 50 pairs of test forms have been bred, the old generation is replaced with the new generation (block 546), and the system resumes from block 541.

The process continues until the difference between the best test form for current and the next succeeding generations is less than a predefined amount (block 547), at which point it saves the final form (block 548) and terminates (block 549).

As an example, if six items are associated with a final form of an assessment, and there are twelve items in the beta passage, there will be 924 possible unique six-item passages that can be formed from the set of 12 items. Thus, for each beta passage, 924 operational length passages can be formed. Then another constraint is imposed upon those 924 operational length passages to reduce that number to a set of valid operational length passages based upon a blueprint requirement, and those remaining make up a passage group.

Each passage, operational or beta, has a profile associated with it. Extracting the profiles for each operational length passage within a passage group creates a smaller set of profiles, because sibling operational length passages, being drawn from a small set of beta passage items, tend to have similar profiles with a small set of shared profiles within the beta passage group. The set of profiles along with their associated frequencies of occurrence within the beta passage group comprises the beta passage profile group.

A computation using the system of the present invention carried out using exemplary data sets is given as follows:

The system begins by reading in the target test items, item pool items, and blueprint from the file containing the data. For this example, those data sets are:

Target test items (p-value is a measure of the item difficulty, with a lower p-value indicating a more difficult item):

| | | | | Rasch Item |
|---|---|---|---|---|
| Item ID | p-Value | Pt Biserial | Biserial | Diff |
| 2104907 | 84 | 0.462 | 0.865 | −0.426 |
| 2104908 | 76 | 0.610 | 0.810 | −0.059 |
| 2104909 | 74 | 0.611 | 0.796 | −0.013 |
| 2104910 | 68 | 0.630 | 0.764 | 0.360 |
| 2104911 | 33 | 0.222 | 0.396 | 1.884 |
| 2104912 | 41 | 0.393 | 0.536 | 1.597 |

Item pool items:

| Seq | | | | | | Rasch Item | | | |
|---|---|---|---|---|---|---|---|---|---|
| Num | ID | Psg ID | p-Value | Pt. Biserial | Biserial | Diff | Obj 1 | Obj 2 | Obj 3 |
| 1 | 3116662 | 1 | 17 | 0.267 | 0.399 | 3.247 | 50 | 62 | 68 |
| 2 | 3116663 | 1 | 33 | 0.293 | 0.381 | 2.160 | 50 | 62 | 68 |
| 3 | 3116664 | 1 | 90 | 0.383 | 0.655 | −1.450 | 50 | 56 | 68 |
| 4 | 3116666 | 2 | 79 | 0.410 | 0.582 | −0.450 | 49 | 56 | 68 |
| 5 | 3116667 | 2 | 80 | 0.400 | 0.571 | −0.490 | 49 | 56 | 68 |
| 6 | 3116668 | 2 | 74 | 0.521 | 0.705 | −0.080 | 49 | 66 | 68 |
| 7 | 3116672 | 3 | 74 | 0.534 | 0.721 | −0.050 | 48 | 53 | 67 |
| 8 | 3116673 | 3 | 84 | 0.556 | 0.834 | −0.790 | 48 | 53 | 67 |
| 9 | 3116674 | 3 | 68 | 0.531 | 0.691 | 0.325 | 48 | 53 | 67 |
| 10 | 3116679 | 4 | 68 | 0.514 | 0.672 | 0.279 | 50 | 56 | 68 |
| 11 | 3116680 | 4 | 38 | 0.210 | 0.268 | 1.860 | 50 | 62 | 68 |
| 12 | 3116681 | 4 | 44 | 0.335 | 0.421 | 1.551 | 50 | 56 | 68 |
| 13 | 3116683 | 5 | 76 | 0.330 | 0.452 | −0.180 | 49 | 66 | 68 |
| 14 | 3116684 | 5 | 77 | 0.553 | 0.767 | −0.280 | 49 | 56 | 68 |
| 15 | 3127811 | 5 | 68 | 0.479 | 0.624 | 0.319 | 49 | 66 | 68 |
| 16 | 3116689 | 6 | 68 | 0.425 | 0.554 | 0.294 | 48 | 53 | 67 |
| 17 | 3116690 | 6 | 79 | 0.595 | 0.839 | −0.400 | 48 | 53 | 67 |
| 18 | 3116691 | 6 | 68 | 0.489 | 0.638 | 0.289 | 48 | 53 | 67 |

Blueprint: Each item maps to one objective in each of three groups, for a total of three objectives for each item:

| Obj ID | Count | Name |
|---|---|---|
| 48 | 2 | Literary |
| 49 | 2 | Informational |
| 50 | 2 | Functional |
| 53 | 2 | Explicit |
| | | Sequence, |
| | | Actions |
| 56 | 2 | Making |
| | | Inferences |
| 62 | 1 | Text |
| | | Characteristics |
| 66 | 1 | Using Fix-Up |
| | | Strategies |
| 67 | 2 | Basic |
| | | Understanding |
| | | (Reading |
| | | Comprehension) |
| 68 | 4 | Thinking Skills |
| | | (Reading |
| | | Comprehension) |

The system then generates each possible passage of the length to be used in the new exam from the items in each passage in the field test. For this example, the passage lengths in the field test are three items per passage, and the passage lengths in the new exam are two items per passage. For each three item passage in the field test, three distinct two-item passages can be produced (items 1, 2, and 3 can be arranged thus: 1-2, 1-3, and 2-3). Therefore, for the six three-item passages in the field test, 18 two-item passages can be produced as candidates for inclusion in the new exam, three candidate passages from each field test passage. Because the set of passages generated from any field test passage all share the same prompt, only one of the set can appear on any one form. The system tracks field test passage membership to preclude multiple usage of any passage prompt on any single form.

For each candidate passage the system uses the objectives that the passage addresses and the number of items within the passage that address each passage to generate a profile. For the candidate passage containing the first two items in the pool (items 3116662 and 31166623) the profile would be “50|2|62|2|68|2”. This means that that passage contains two items that address objective 50, two items that address objective 62, and two items that address objective 68. The profiles are built and formatted in a standard way to allow the system to check two profiles for equivalence.

Within each field test passage, the system identifies all the profiles associated with the candidate passages (there may be fewer unique profiles than there are passages, if two or more candidate passages share the same profile). It counts the number of candidate passages associated with each unique profile, again within field test passages. Finally, within each field test passage the system sorts the profiles according to their counts, with the most common profiles first.

Program log file output for the sample data addressed herein is included, with the use of a standard programming font. Comments are in bold.

For passage ID: 1 1 profiles found. Max count=2. Min count=2

For passage ID: 2 2 profiles found. Max count=2. Min count=1

For passage ID: 3 1 profiles found. Max count=3. Min count=3

For passage ID: 4 2 profiles found. Max count=2. Min count=1

For passage ID: 5 1 profiles found. Max count=2. Min count=2

For passage ID: 6 1 profiles found. Max count=3. Min count=3

Here the system has constructed all the candidate passage profiles, counted the number of times each unique profile appears within each field test passage, and sorted the profiles by their counts, with the most common profiles first. The output shows the number of profiles found, and the minimum and maximum profile counts for each field test passage. At this point also the system checks the passage for objectives that have more items assigned than the blueprint allows for, and excludes profiles for those as they cannot be used in a form that conforms to the blueprint. This is why passages 1 and 5 have only one profile with a count of two; the “missing” profile has been excluded in each case because it had two items mapped to an objective that only required one item.

In the next step the system randomly selects a field test passage. A profile is randomly selected from the top 10% most common profiles (or the most common profile is selected if there are fewer than 10 profiles) associated with the field test passage. This profile is added to the candidate form, and the system then checks if another passage is needed to reach the desired number of passages and items. If another passage is required, the system follows the same procedure with the remaining eligible field test passages.

Build started

Passage ID 1 profile # 0 selected for initial build.

Passage ID 1 profile # 0 profile: 50|2|56|1|62|1|68|2

Profile count=2
   Passage ID 6 profile # 0 selected for initial build.
Passage ID 6 profile # 0 profile: 48|2|53|2|67|2
Profile count 3
   Passage ID 4 profile # 0 selected for initial build.
Passage ID 4 profile # 0 profile: 50|2|56|1|62|1|68|2
Profile count=2
   # of discrepant items=3
   For the initial candidate form, the system selected profiles from field test passages 1, 6, and 4. This resulted in a difference between the candidate form and the blueprint of three items.

The system then follows the following procedure until concordance with the blueprint is achieved:

1. Drop a profile from the current candidate form (starting with the first and proceeding sequentially in subsequent cycles).

a. Select a pool passage that is not associated with any field test passages remaining on the exam (starting with the first and proceeding sequentially in subsequent cycles).
(i). Select a profile from the pool passage (starting with the first and proceeding sequentially in subsequent cycles).
(ii). Add the profile to the candidate form.
(iii). Check the deviation from the blueprint.
(iv). If the deviation is zero (i.e., concordance with the blueprint has been achieved), place the profile on the form and exit the procedure.
(v). If the deviation with the current profile is less than the current deviation, update the current deviation and cache the profile.
(vi). Proceed with the next profile, if available.

b. Proceed with the next pool passage, if available.

2. If a profile was cached in step 1.a.v, place on candidate form.

3. If no profile was cached, replace the profile dropped in step 1 on the form

4. Proceed with the next profile on the form if available. If no more profiles are available, return to the first item on the form.

The above procedure continues until the deviation from the blueprint reaches zero. Also, if the system runs one complete cycle through the profiles in the candidate form without any improvements in the deviation from the blueprint, the current candidate form is discarded and the system starts over with a new initial candidate form. If there are sufficient items in the pool to fill all the objectives in the blueprint, the system will generally be able to come to agreement with the blueprint within the first three or four candidate forms that it generates. Required times to generate a candidate form that matches the blueprint range from a fraction of a second for low-complexity tests (tests that do not use passage-based items or tests with few items per passage) to ˜|0 minutes for high-complexity tests (passage-based tests with >8 items per passage). An exemplary flow of the system for sample data now follows.

Drop passage id: 1 (the program first attempts to replace the profile associated with field test passage 1)

3 (deviation of the profile that is being substituted for the dropped passage) is greater than or equal to the current deviation of 3 (deviation before the passage was dropped) passage id 1 not selected.

Profile of original (dropped) item 50|2|56|1|62|1|68|2

Profile of rejected (substituted) item 50|2|56|1|62|1|68|2

0 is less than the current deviation of 3 passage id 2 now selected.

Profile of original item 50|2|56|1|62|1|68|2

Profile of replacement item 49|2|56|1|66|1|68|2

Final replacement passage is ID 2 (And the blueprint has been matched . . . so the process is complete)

Build ended

Elapsed time: 00:00:00.0600864 ( 6/100 of a second)

At this point the system goes back to the passage pool, selects passages that match the profiles selected for inclusion, and replaces the profiles with their matching passages. If a profile matches more than one passage, a passage is arbitrarily chosen from the set of matches. At this point, the system has a candidate form that matches the blueprint. The next phase of the system takes the candidate form and optimizes it to match the target form statistics as closely as possible.

The statistical optimization phase proceeds as follows:

1. Calculate the difference between the test information curves for the candidate form and the target form.

2. Calculate the difference between the test characteristic curves for the candidate form and the target form.

3. Calculate the difference between the estimated mean scores for the candidate form and the target form.

4. Apply the weights to the results of steps 1-3 and sum. This is the criterion value.

5. Drop a passage from the current candidate form (starting at a random position within the candidate form and proceeding sequentially in subsequent cycles, moving to the first passage in the form when the last item is reached and has been processed).
a. Select a candidate passage from the pool (starting with the first and proceeding sequentially in subsequent cycles).
b. If the selected candidate passage does not map to a field test passage that is currently on the candidate form and has a profile that matches the item that was dropped in step 5, then proceed to the next step; otherwise proceed with the next pool passage, if available (go back to the previous step).
c. Add the candidate passage selected in the previous step to the form.
d. Calculate the difference between the test information curves for the candidate form and the target form.
e. Calculate the difference between the test characteristic curves for the candidate form and the target form.
f. Calculate the difference between the estimated mean scores for the candidate form and the target form.
g. Apply the weights to the results of steps 1-3 and sum. This is the criterion value for the current pool passage.
h. If the criterion value for the current pool passage is less than that for the dropped passage, cache the current pool passage and update the criterion value.
i. Proceed with the next pool passage, if available.

6. If a passage was cached in step 1.5.h, place on candidate form.

7. If no passage was cached, replace the passage dropped in step 5 on the form.

8. Proceed with the next passage on the form if available. If no more passages are available, return to the first item on the form.

This procedure continues until a complete pass has been made through all passages in the forms without any improvement in the statistical match between the candidate form and the target form. To follow is an exemplary annotated run log.

Optimization started

Passage ID 4 dropped.

The difference between the TICs and TCCs are calculated as the sum of the absolute differences between the curves from −4 to 4, at intervals of 0.05. The difference between the means is calculated as the absolute difference in the sum pf the p-values. The criterion value is a weighted sum of the TIC difference, TCC difference, and Mean difference (difference between the estimated means). In this example, the weights are all equal to 1, and so the criterion difference is a straight sum.

Initial differences

TIC difference=29.5740
TCC difference=22.4365
Mean difference=0.2000
Criterion difference=52.2105 Number to beat to switch out item.
   Passage ID 3 rejected. Profiles not equal or passage in use
   Original profile: 50|2|56|1|62|1|68|2
   Replacement profile: 48|2|53|2|67|2
   Passage ID 3 rejected. Profiles not equal or passage in use
   Original profile: 50|2|56|1|62|1|68|2
   Replacement profile: 48|2|53|2|67|2
   Passage ID 3 rejected. Profiles not equal or passage in use
   Original profile: 50|2|56|1|62 |1|68|2
   Replacement profile: 48|2|53|2|67|2
   Passage ID 2 rejected. Profiles not equal or passage in use
   Original profile: 50|2|56|1|62 1|68|2
   Replacement profile: 49|2|56|2|68|2
   Passage ID 2 rejected. Profiles not equal or passage in use
   Original profile: 50|2|56|1|62|1|68|2
   Replacement profile: 49|2|56|1|66|1|68|2
   Passage ID 2 rejected. Profiles not equal or passage in use
   Original profile: 50|2|56|1|62|1|68|2
   Replacement profile: 49|2|56|1|66|1|68|2
   Passage ID 4 rejected. Profiles not equal or passage in use
   Original profile: 50|2|56|1|62|1|68|2
   Replacement profile: 50|2|56|2|68|2
   Passage rejected. Criterion of 52.2105267982881 is not less than current value of 52.2105267982881 To make switch, criterion must be less than current.
   Original passage ID 4 profile is 50|2|56|1|62|1|68|2
   Rejected passage ID 4 profile is 50|2|56|1|62|1|68|2
   Passage replaced. Criterion of 5.37946033975793 is less than current value of 52.2105267982881 Current passage from passage ID 4 is replaced with a different set of items from the same field test passage. Here the criterion is updated and the passage cached.
   Original passage ID 4 profile is 50|2|56|1|62|1|68|2
   Replacement passage ID 4 profile is 50|2|56|1|62|1|68|2
   Passage rejected. Criterion of 108.519540028211 is not less than current value of 5.37946033975793 This passage from field test passage 1 has the same profile, but the stat match is worse.
   Original passage ID 4 profile is 50|2|56|1|62|1|68|2
   Rejected passage ID 1 profile is 50|2|56|1|62|1|68|2
   Passage rejected. Criterion of 110.67516109585 is not less than current value of 5.37946033975793 Another match, but not better than the current match.
   Original passage ID 4 profile is 50|2|56|1|62|1|68|2
   Rejected passage ID 1 profile is 50|2|56|1|62|1|68|2
   Passage ID 1 rejected. Profiles not equal or passage in use
   Original profile: 50|2|56|1|62|1|68|2
   Replacement profile: 50|2|62|2|68|2
   From this point on, each repeated series of messages “Passage ID x rejected. Profiles not equal or passage in use” along with their associated profiles after the first occurrence will be replaced with an ellipsis (as below) for sake of brevity.
   { . . . }
   Final replacement is passage ID 4. Place the passage cached earlier on the form.
TIC difference=3.5192
TCC difference=1.8203
Mean difference=0.0400
Criterion difference=5.3795
   Passage ID 2 dropped.
   Initial differences
TIC difference=3.5192
TCC difference=1.8203
Mean difference=0.0400
Criterion difference=5.3795
   Passage ID 3 rejected. Profiles not equal or passage in use
   Original profile: 49|2|56|1|66|1|68|2
   Replacement profile: 48|2|53|2|67|2
   { . . . }
   Passage rejected. Criterion of 5.37946033975794 is not less than current value of 5.37946033975794
   Original passage ID 2 profile is 49|2|56|1|66|1|68|2
   Rejected passage ID 2 profile is 49|2|56|1|66|1|68|2
   Passage rejected. Criterion of 7.06464359364037 is not less than current value of 5.37946033975794 Slightly worse
   Original passage ID 2 profile is 49|2|56|1|66|1|68|2
   Rejected passage ID 2 profile is 49|2|56|1|66|1|68|2
   Passage ID 4 rejected. Profiles not equal or passage in use
   Original profile: 49|2|56|1|66 |1|68|2
   Replacement profile: 50|2|5612|68|2
   { . . . }
   Passage rejected. Criterion of 33.0157331637555 is not less than current value of 5.37946033975794
   Original passage ID 2 profile is 49|2|56|1|66|1|68|2
   Rejected passage ID 5 profile is 49|2|56|1|66|1|68|2
   Passage ID 5 rejected. Profiles not equal or passage in use
   Original profile: 49|2|56|1|66|1|68|2
   Replacement profile: 49|2|66|2|68|2
   Passage rejected. Criterion of 10.1414032962944 is not less than current value of 5.37946033975794
   Original passage ID 2 profile is 49|2|56|1|66 1|68|2
   Rejected passage ID 5 profile is 49|2|56|1|66|1|68|2
   No replacement made—no better match found.
   Passage ID 6 dropped.
   Initial differences
TIC difference=3.5192
TCC difference=1.8203
Mean difference=0.0400
Criterion difference=5.3795
   Passage rejected. Criterion of 9.17277695907957 is not less than current value of 5.37946033975794
   Original passage ID 6 profile is 48|2|53|2|67|2
   Rejected passage ID 3 profile is 48|2|53|2|67|2
   Passage rejected. Criterion of 42.6710934649276 is not less than current value of 5.37946033975794
   Original passage ID 6 profile is 48|2|53|2|67|2
   Rejected passage ID 3 profile is 48|2|53|2|67|2
   Passage rejected. Criterion of 59.633625545491 is not less than current value of 5.37946033975794
   Original passage ID 6 profile is 48|2|53|2|67|2
   Rejected passage ID 3 profile is 48|2|53|2|67|2
   Passage ID 2 rejected. Profiles not equal or passage in use
   Original profile: 48|2|53|2|67|2
   Replacement profile: 49|2|56|2|68|2
   Passage rejected. Criterion of 5.37946033975794 is not less than current value of 5.37946033975794
   Original passage ID 6 profile is 48|2|53|2|67|2
   Rejected passage ID 6 profile is 48|2|53|2|67|2
   Passage rejected. Criterion of 26.8113883743234 is not less than current value of 5.37946033975794
   Original passage ID 6 profile is 48|2|53|2|67|2
   Rejected passage ID 6 profile is 48|2|53|2|67|2
   Passage rejected. Criterion of 26.5856255026093 is not less than current value of 5.37946033975794
   Original passage ID 6 profile is 48|2|53|2|67|2
   Rejected passage ID 6 profile is 48|2|53|2|67|2
   Passage ID 5 rejected. Profiles not equal or passage in use
   Original profile: 48|2|53|2|67|2
   Replacement profile: 49|2|56|1|66|1|68|2
   { . . . }
   No replacement made. All items in the form have been checked, but a replacement was made, so the program now runs through the form a second time, randomly beginning with passage id 6.
   Passage ID 6 dropped.
   Initial differences
TIC difference=3.5192
TCC difference=1.8203
Mean difference=0.0400
Criterion difference=5.3795
   Passage rejected. Criterion of 9.17277695907957 is not less than current value of 5.37946033975794
   Original passage ID 6 profile is 48|2|53|2|67|2
   Rejected passage ID 3 profile is 48|2|53|2|67|2
   Passage rejected. Criterion of 42.6710934649276 is not less than current value of 5.37946033975794
   Original passage ID 6 profile is 48|2|53|2|67|2
   Rejected passage ID 3 profile is 48|2|53|2|67|2
   Passage rejected. Criterion of 59.633625545491 is not less than current value of 5.37946033975794
   Original passage ID 6 profile is 48|2|53|2|67|2
   Rejected passage ID 3 profile is 48|2|53|2|67|2
   Passage ID 2 rejected. Profiles not equal or passage in use
   Original profile: 48|2|53|2|67|2
   Replacement profile: 49|2|56|2|68|2
   { . . . }
   Passage rejected. Criterion of 5.37946033975794 is not less than current value of 5.37946033975794
   Original passage ID 6 profile is 48|2|53|2|67|2
   Rejected passage ID 6 profile is 48|2|53|2|67|2
   Passage rejected. Criterion of 26.8113883743234 is not less than current value of 5.37946033975794
   Original passage ID 6 profile is 48|2|53|2|67|2
   Rejected passage ID 6 profile is 48|2|53|2|67|2
   Passage rejected. Criterion of 26.5856255026093 is not less than current value of 5.37946033975794
   Original passage ID 6 profile is 48|2|53|2|67|2
   Rejected passage ID 6 profile is 48|2|53|2|67|2
   Passage ID 5 rejected. Profiles not equal or passage in use
   Original profile: 48|2|53|2|67|2
   Replacement profile: 49|2|56|1|66|1|68|2
   { . . . }
   No replacement made.
   Passage ID 4 dropped.
   Initial differences
TIC difference=3.5192
TCC difference=1.8203
Mean difference=0.0400
Criterion difference=5.3795
   Passage ID 3 rejected. Profiles not equal or passage in use
   Original profile: 50|2|56|1|62 |1|68|2
   { . . . }
   Replacement profile: 48|2|53|2|67|2
   Passage rejected. Criterion of 52.2105267982881 is not less than current value of 5.37946033975794
   Original passage ID 4 profile is 50|2|56|1|62|1|68|2
   Rejected passage ID 4 profile is 50|2|56|1|62|1|68|2
   Passage rejected. Criterion of 5.37946033975794 is not less than current value of 5.37946033975794
   Original passage ID 4 profile is 50|2|56|1|62|1|68|2
   Rejected passage ID 4 profile is 50|2|56|1|62|1|68|2
   Passage rejected. Criterion of 108.519540028211 is not less than current value of 5.37946033975794
   Original passage ID 4 profile is 50|2|56|1|62|1|68|2
   Rejected passage ID 1 profile is 50|2||56 1|62|168|2
   Passage rejected. Criterion of 110.67516109585 is not less than current value of 5.37946033975794
   Original passage ID 4 profile is 50|2|56|1|62|1|68|2
   Rejected passage ID 1 profile is 50|2|56|1|62|1|68|2
   Passage ID 1 rejected. Profiles not equal or passage in use
   Original profile: 50|2|56|1|62 |1|68|2
   Replacement profile: 50|2|62|2|68|2
   { . . . }
   No replacement made.
   Passage ID 2 dropped.
   Initial differences
TIC difference=3.5192
TCC difference=1.8203
Mean difference=0.0400
Criterion difference=5.3795
   Passage ID 3 rejected. Profiles not equal or passage in use
   Original profile: 49|2|56|1|66|1|68|2
   Replacement profile: 48|2|53|2|67|2
   { . . . }
   Passage rejected. Criterion of 5.37946033975794 is not less than current value of 5.37946033975794
   Original passage ID 2 profile is 49|2|56|1|66|1|68|2
   Rejected passage ID 2 profile is 49|2|56|1|66|1|68|2
   Passage rejected. Criterion of 7.06464359364037 is not less than current value of 5.37946033975794
   Original passage ID 2 profile is 49|2|56|1|66|1|68|2
   Rejected passage ID 2 profile is 49|2|56|1|66|1|68|2
   Passage ID 4 rejected. Profiles not equal or passage in use
   Original profile: 49|2|56|1|66|1|68|2
   Replacement profile: 50|2|56|2|68|2
   { . . . }
   Passage rejected. Criterion of 33.0157331637555 is not less than current value of 5.37946033975794
   Original passage ID 2 profile is 49|2|56|1|66|1|68|2
   Rejected passage ID 5 profile is 49|2|56|1|66|1|68|2
   Passage ID 5 rejected. Profiles not equal or passage in use
   Original profile: 49|2|56|1|66|1|68|2
   Replacement profile: 49|2|66|2|68|2
   Passage rejected. Criterion of 10.1414032962944 is not less than current value of 5.37946033975794
   Original passage ID 2 profile is 49|2|56|1|66|1|68|2
   Rejected passage ID 5 profile is 49|2|56|1|66|1|68|2
   All items have been checked with no improvements, and so no further improvements are possible. The program ends.
   Build ended
   Elapsed time: 00:00:03.3648384

The form produced by the run documented by the log in this document is presented below.

| Orig. | | | | | | | | | |
|---|---|---|---|---|---|---|---|---|---|
| Seq. | | Psg | p- | Point | | Rasch Item | | | |
| No. | Item ID | ID | Value | Biserial | Biserial | Diff | Clusters | | |
| 5 | 3116667 | 2 | 80 | 0.400 | 0.571 | −0.490 | Informational | Making | Thinking Skills |
| | | | | | | | | Inferences | (Reading |
| | | | | | | | | | Comprehension) |
| 6 | 3116668 | 2 | 74 | 0.521 | 0.705 | −0.080 | Informational | Using Fix-Up | Thinking Skills |
| | | | | | | | | Strategies | (Reading |
| | | | | | | | | | Comprehension) |
| 11 | 3116680 | 4 | 38 | 0.210 | 0.268 | 1.860 | Functional | Text Characteristics | Thinking Skills |
| | | | | | | | | | (Reading |
| | | | | | | | | | Comprehension) |
| 12 | 3116681 | 4 | 44 | 0.335 | 0.421 | 1.551 | Functional | Making | Thinking Skills |
| | | | | | | | | Inferences | (Reading |
| | | | | | | | | | Comprehension) |
| 16 | 3116689 | 6 | 68 | 0.425 | 0.554 | 0.294 | Literary | Explicit | Basic |
| | | | | | | | | Sequence, | Understanding |
| | | | | | | | | Actions | (Reading |
| | | | | | | | | | Comprehension) |
| 18 | 3116691 | 6 | 68 | 0.489 | 0.638 | 0.289 | Literary | Explicit | Basic |
| | | | | | | | | Sequence, | Understanding |
| | | | | | | | | Actions | (Reading |
| | | | | | | | | | Comprehension) |

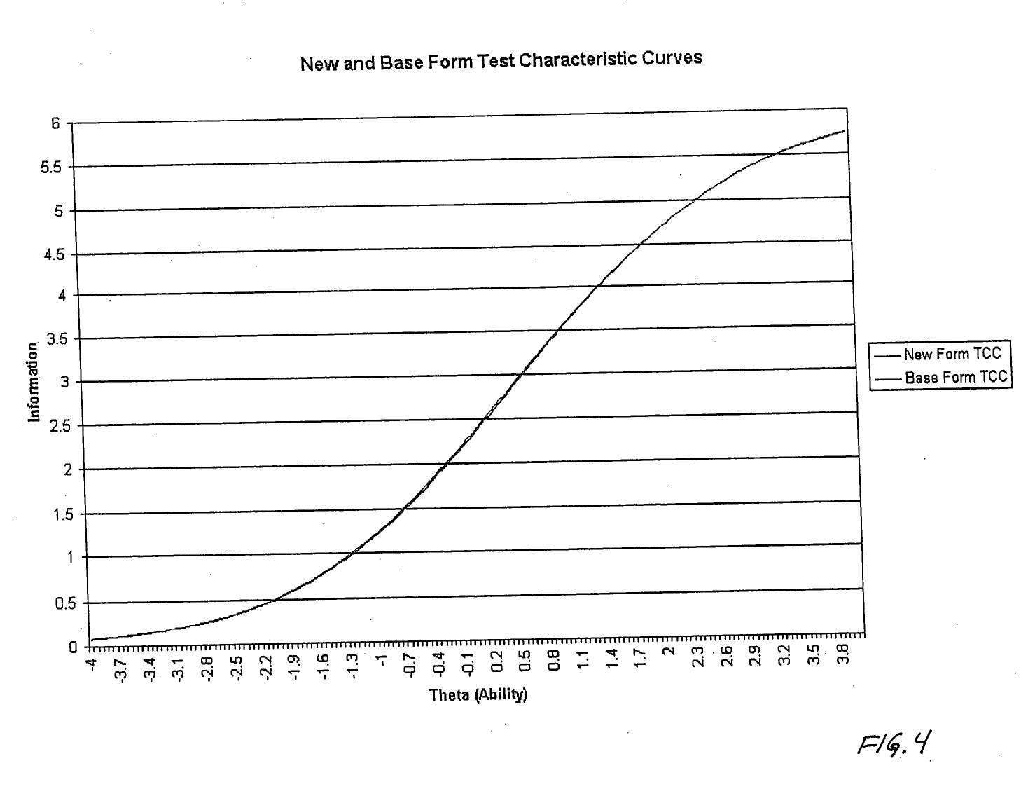

FIGS. 3 and 4 show the match of the new generated form to the target form. As can be seen, the match between the target form and the new form is statistically very tight. Within this sample data set there are at least three more forms that can be constructed that also have a perfect match to the blueprint and have as high a degree of statistical fidelity as the form whose construction is documented herein. Indeed, two of the three forms have a higher degree of statistical match to the target form.

In an exemplary embodiment, the present system constructs from a pool of test items that have been pretested on a sample drawn from the target population a test form that matches a predetermined curriculum structure (blueprint) and that matches the test-level statistics of a predetermined extant test form. The system, as described above, operates in two phases, first defining a content framework that fills the requirements embodied within the blueprint, and then “filling out” the aforementioned framework with a specific set of items that most closely matches the test level statistics of the target form. This splitting of the task into two phases rather than attempting to simultaneously address both content and statistical constraints permits a better match to all constraints in less time with simpler operation than other known approaches.

It may be appreciated by one skilled in the art that additional embodiments may be contemplated without departing from the spirit of the invention, including alternate search algorithms and statistics.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the system and method illustrated and described herein are by way of example, and the scope of the invention is not limited to the exact details of implementation.

Having now described the invention, the construction, the operation and use of preferred embodiments thereof, and the advantageous new and useful results obtained thereby, the new and useful constructions, and reasonable mechanical equivalents thereof obvious to those skilled in the art, are set forth in the appended claims.

What is claimed is:

1. A method of assembling an assessment having a predetermined target content structure and target statistics from a pool of passages, each passage having associated therewith a content profile and passage statistics, the method comprising the steps of:
a. selecting from the passage pool a predetermined number of content profiles to create a candidate form, the candidate form having a content structure based upon a sum of the content profiles;
b. comparing the candidate form content structure with the target content structure;
c. if a difference between the candidate form content structure and the target content structure is a currently lowest value, retaining the candidate form as a closest match;
d. repeating steps (a)-(c) until the retained closest match candidate matches the target content structure;
e. populating the retained closest match candidate form with a plurality of passages meeting the form content structure to create a potential assessment;
f. calculating test statistics for the potential assessment;
g. if a difference between the calculated test statistics and the target statistics is a currently lowest value, retaining the potential assessment as a candidate assessment; and
h. repeating steps (e)-(g) until all possible potential assessments have been created.

2. The method recited in claim 1, further comprising the step, prior to step (a), of creating at least one multiple-item passage in the pool from a plurality of items associated therewith.

3. The method recited in claim 2, further comprising the steps of:
providing a set of a first number of associated items;
determining a second number of items to be included in the multiple-item passage, the second number smaller than the first number; and
wherein the passage-creating step comprises creating all possible combinations of the first number of items to yield a multiple-item passage having the first number of items therein.

4. The method recited in claim 1, wherein the assessment further has a predetermined target information curve and each passage has associated therewith an information curve, and wherein step (a) comprises:
for each passage, calculating a difference between a peak of the target information curve and a peak of the passage information curve;
associating the distance with each passage content profile;
sorting the passage content profiles according to passage distances; and
selecting the content profiles preferentially according to smallest passage distances to create the candidate form.

5. The method recited in claim 1, wherein step (a) comprises:
for each different content profile, counting a number of passages that share a common content profile;
sorting the profiles according to number of shared passages; and
selecting the content profiles preferentially according to greatest number of shared passages to create the candidate form.

6. A method of assembling an assessment having a predetermined target content structure and target statistics from a pool of passages, each passage having associated therewith a content profile and passage statistics, the method comprising the steps of:
a. selecting from the passage pool a predetermined number of content profiles to create a candidate form, the candidate form having a content structure based upon a sum of the content profiles;
b. comparing the candidate form content structure with the target content structure;
c. if a difference between the candidate form content structure and the target content structure is a currently lowest value, retaining the candidate form as a closest match;
d. repeating steps (a)-(c) until the retained closest match candidate matches the target content structure;
e. randomly populating the retained closest match candidate form with a plurality of passages meeting the form content structure to create a potential assessment;
f. calculating test statistics for the potential assessment;
g. repeating steps (e) and (f) a plurality of times;
h. sorting the created potential assessments according to a distance between the respective calculated test statistics and the target statistics;
i. selecting a closest potential assessment from the sorting step;
j. searching among the potential assessments for a form complementary to the closest potential assessment;
k. forming a progeny assessment by randomly selecting a sequence of alternative passages from each of the closest potential assessment and the complementary assessment;
l. calculating test statistics for the progeny assessment;
m. repeating steps (k) and (l) a plurality of times; and
n. identifying a progeny assessment having a closest match to the target test statistics.

7. The method recited in claim 6, further comprising the step, prior to step (a), of creating at least one multiple-item passage in the pool from a plurality of items associated therewith.

8. The method recited in claim 7, further comprising the steps of:
providing a set of a first number of associated items;
determining a second number of items to be included in the multiple-item passage, the second number smaller than the first number; and
wherein the passage-creating step comprises creating all possible combinations of the first number of items to yield a multiple-item passage having the first number of items therein.

9. The method recited in claim 6, wherein the assessment further has a predetermined target information curve and each passage has associated therewith an information curve, and wherein step (a) comprises:
for each passage, calculating a difference between a peak of the target information curve and a peak of the passage information curve;
associating the distance with each passage content profile;
sorting the passage content profiles according to passage distances; and
selecting the content profiles preferentially according to smallest passage distances to create the candidate form.

10. The method recited in claim 6, wherein step (a) comprises:
for each different content profile, counting a number of passages that share a common content profile;
sorting the profiles according to number of shared passages; and
selecting the content profiles preferentially according to greatest number of shared passages to create the candidate form.

11. A computer-readable medium having stored thereon a software package for assembling an assessment having a predetermined target content structure and target statistics from a pool of passages, each passage having associated therewith a content profile and passage statistics, the software package comprising code segments adapted to:
a. select from the passage pool a predetermined number of content profiles to create a candidate form, the candidate form having a content structure based upon a sum of the content profiles;
b. compare the candidate form content structure with the target content structure;
c. if a difference between the candidate form content structure and the target content structure is a currently lowest value, retain the candidate form as a closest match;
d. repeat code segments (a)-(c) until the retained closest match candidate matches the target content structure;
e. populate the retained closest match candidate form with a plurality of passages meeting the form content structure to create a potential assessment;
f. calculate test statistics for the potential assessment;
g. if a difference between the calculated test statistics and the target statistics is a currently lowest value, retain the potential assessment as a candidate assessment; and
h. repeat code segments (e)-(g) until all possible potential assessments have been created.

12. The computer-readable medium recited in claim 11, wherein the software package further comprises a code segment adapted to, prior to code segment (a), create at least one multiple-item passage in the pool from a plurality of items associated therewith.

13. The computer-readable medium recited in claim 12, wherein the software package further comprises code segments adapted to:
provide a set of a first number of associated items;
determine a second number of items to be included in the multiple-item passage, the second number smaller than the first number; and
wherein the passage-creating code segment is adapted to create all possible combinations of the first number of items to yield a multiple-item passage having the first number of items therein.

14. The computer-readable medium recited in claim 11, wherein the assessment further has a predetermined target information curve and each passage has associated therewith an information curve, and wherein code segment (a) is adapted to:
for each passage, calculate a difference between a peak of the target information curve and a peak of the passage information curve;
associate the distance with each passage content profile;
sort the passage content profiles according to passage distances; and
select the content profiles preferentially according to smallest passage distances to create the candidate form.

15. The computer-readable medium recited in claim 11, wherein code segment (a) is adapted to:
for each different content profile, count a number of passages that share a common content profile;
sort the profiles according to number of shared passages; and
select the content profiles preferentially according to greatest number of shared passages to create the candidate form.

16. A computer-readable medium having stored thereon a software package for assembling an assessment having a predetermined target content structure and target statistics from a pool of passages, each passage having associated therewith a content profile and passage statistics, the software package having code segments adapted to:
a. select from the passage pool a predetermined number of content profiles to create a candidate form, the candidate form having a content structure based upon a sum of the content profiles;
b. compare the candidate form content structure with the target content structure;
c. if a difference between the candidate form content structure and the target content structure is a currently lowest value, retain the candidate form as a closest match;
d. repeat code segments (a)-(c) until the retained closest match candidate matches the target content structure;
e. randomly populate the retained closest match candidate form with a plurality of passages meeting the form content structure to create a potential assessment;
f. calculate test statistics for the potential assessment;
g. repeat code segments (e) and (f) a plurality of times;
h. sort the created potential assessments according to a distance between the respective calculated test statistics and the target statistics;
i. select a closest potential assessment from the sorting step;
j. search among the potential assessments for a form complementary to the closest potential assessment;
k. form a progeny assessment by randomly selecting a sequence of alternative passages from each of the closest potential assessment and the complementary assessment;
l. calculate test statistics for the progeny assessment;
m. repeat code segments (k) and (l) a plurality of times; and
n. identify a progeny assessment having a closest match to the target test statistics.

17. The computer-readable medium recited in claim 16, wherein the software package further comprises code segments adapted to, prior to code segment (a), create at least one multiple-item passage in the pool from a plurality of items associated therewith.

18. The computer-readable medium recited in claim 17, wherein the software package further comprises code segments adapted to:
provide a set of a first number of associated items;
determine a second number of items to be included in the multiple-item passage, the second number smaller than the first number; and
wherein the passage-creating code segment is adapted to create all possible combinations of the first number of items to yield a multiple-item passage having the first number of items therein.

19. The computer-readable medium recited in claim 16, wherein the assessment further has a predetermined target information curve and each passage has associated therewith an information curve, and wherein code segment (a) is adapted to:
for each passage, calculate a difference between a peak of the target information curve and a peak of the passage information curve;
associate the distance with each passage content profile;
sort the passage content profiles according to passage distances; and
select the content profiles preferentially according to smallest passage distances to create the candidate form.

20. The computer-readable medium recited in claim 16, wherein code segment (a) is adapted to:
for each different content profile, count a number of passages that share a common content profile;
sort the profiles according to number of shared passages; and
select the content profiles preferentially according to greatest number of shared passages to create the candidate form.
